(19) United States
(12) Patent Application Publication
(10) Pub. No.: US 2017/0043704 A1
(43) Pub. Date: Feb. 16, 2017

(54) METHOD AND SYSTEM FOR CONTROLLING A LAMP IN RIDDEN VEHICLE

(71) Applicants: Le Holdings(Beijing)Co., Ltd., Beijing (CN); LETV SPORTS CULTURE DEVELOP(BEIJING) CO., LTD., Beijing (CN)

(72) Inventor: Dalong LI, Beijing (CN)

(21) Appl. No.: 15/222,877

(22) Filed: Jul. 28, 2016

Related U.S. Application Data
(63) Continuation of application No. PCT/CN2016/082054, filed on May 13, 2016.

(30) Foreign Application Priority Data
Aug. 11, 2015 (CN) 201510491528.8

(51) Int. Cl. B60Q 1/14; B62J 6/00; B62J 6/02; H05B 37/02

(52) U.S. Cl. CPC B60Q 1/1407; H05B 37/0218; B62J 6/001; B62J 6/02; B60Q 2300/314; B60Q 2300/116

(57) ABSTRACT

Embodiments of the disclosure provide a method and system for controlling a lamp in a ridden vehicle. The method includes: detecting a brightness value of light rays in the current environment of the ridden vehicle; and controlling the front lamp of the ridden vehicle to be switched on and off, according to the brightness value of light rays. With the technical solution according to the embodiments of the disclosure, the brightness value of light rays in the current environment of the ridden vehicle can be detected, and the brightness value of the front lamp of the ridden vehicle can be adjusted automatically, so that the front lamp of the ridden vehicle can be switched on automatically at nighttime or if there are insufficient light rays to thereby improve the safety of a rider while riding at dark so as to improve the experience of the user.

### CROSS REFERENCE TO RELATED APPLICATIONS

This application is a continuation of International Application No. PCT/CN2016/082054, filed on May 13, 2016, which is based upon and claims priority to Chinese Patent Application No. 201510491528.8, filed with the Chinese Patent Office on Aug. 11, 2015 and entitled “Method and system for controlling a lamp in ridden vehicle”, which is hereby incorporated by reference in its entirety.

### TECHNICAL FIELD

The present disclosure relates to the field of manufacturing a ridden vehicle, and particularly to a method and system for controlling a lamp in a ridden vehicle.

### BACKGROUND

At present, bicycling has become increasingly popular as a low-carbon, environment-conserving, and healthy sporting and traveling mode. Many riders prefer to listen to music or a radio station, or prefer other entertainment means while bicycling to make their bicycling more joyful.

The majority of existing bicycles are not provided with lamps so that the riders can not see clearly their front roads at dark, which may tend to come with an accident, thus resulting in a hidden risk of safety.

Moreover some owners of bicycles may install lamps on their bicycles by themselves, which need to be switched on by their riders themselves at dark, but the lamps may not be accessed conveniently, and the riders may tend to forget to switch on them, which may also result in a hidden risk of safety.

In view of this, it is highly desirable in the industry to improve the safety of the riders while riding at dark.

### SUMMARY

Embodiments of the disclosure provide a method and system for controlling a lamp in a ridden vehicle to thereby address the problem in the prior art of a hidden risk of safety of a rider while riding at dark so as to satisfy the user and to improve the experience of the user.

An embodiment of the disclosure provides a method for controlling a lamp in a ridden vehicle, the method including:
detecting a brightness value of light rays in the current environment of the ridden vehicle; and
controlling the front lamp of the ridden vehicle to be switched on and off, according to the brightness value of light rays.

An embodiment of the disclosure provides a system for controlling a lamp in a ridden vehicle, the system including a front lamp device, a brightness detecting device, and a controller, wherein:
the brightness detecting device is configured to detect a brightness value of light rays in the current environment of the ridden vehicle, and to transmit the brightness value of light rays to the controller; and
the controller is configured to receive the brightness value of light rays transmitted by the brightness detecting device, and to control the front lamp device of the ridden vehicle to be switched on and off, according to the brightness value of light rays.

With the method and system for controlling a lamp in a ridden vehicle according to the embodiments of the disclosure, the method includes: detecting a brightness value of light rays in the current environment of the ridden vehicle; and controlling the front lamp of the ridden vehicle to be switched on and off, according to the brightness value of light rays. With the technical solution according to the embodiments of the disclosure, the brightness value of light rays in the current environment of the ridden vehicle can be detected, and the brightness value of the front lamp of the ridden vehicle can be adjusted automatically, so that the front lamp of the ridden vehicle can be switched on automatically at nighttime or if there are insufficient light rays to thereby improve the safety of a rider while riding at dark so as to better satisfy the user and to improve the experience of the user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for controlling a lamp in a ridden vehicle according to an embodiment of the disclosure;

FIG. 2 is a flow chart of another method for controlling a lamp in a ridden vehicle according to an embodiment of the disclosure;

FIG. 3 is a flow chart of a further method for controlling a lamp in a ridden vehicle according to an embodiment of the disclosure;

FIG. 4A is a schematic structural diagram of a system for controlling a lamp in a ridden vehicle according to an embodiment of the disclosure;

FIG. 4B is another schematic structural diagram of a system for controlling a lamp in a ridden vehicle according to an embodiment of the disclosure; and

FIG. 4C is a schematic structural diagram of a system for controlling a lamp in a ridden vehicle according to a further embodiment of the disclosure,

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

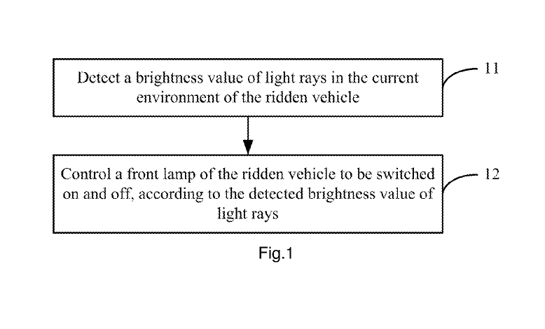

Referring to FIG. 1, an embodiment of the disclosure provides a method for controlling a lamp in a ridden vehicle, a particular flow of which is as follows:

The step 11 is to detect a brightness value of light rays in the current environment of the ridden vehicle.

The “ridden vehicle” as referred to in an embodiment of the disclosure can refer to a bicycle, an electric vehicle, or a motorcycle.

In an embodiment of the disclosure, the brightness value of light rays in the current environment of the ridden vehicle can be detected by a light ray sensor. Particularly the brightness value of light rays in the current environment of the ridden vehicle can be detected in real time, or the brightness value of light rays in the current environment of the ridden vehicle can be detected at a preset periodicity of time.

The step 12 is to control a front lamp of the ridden vehicle to be switched on and off, according to the detected brightness value of light rays.

Particularly the “front” lamp of the ridden vehicle is typically a lamp including a reflecting mirror and a specialized lens, which can be installed at the front of the vehicle body and configured to illuminate a front road so that a driver of the ridden vehicle can observe the road condition in front of the vehicle.

In an embodiment of the disclosure, the step 12 can be performed in the following steps without any limitation thereto:
1. If the detected brightness value of light rays is below a preset brightness threshold, then it will indicate insufficient light rays in the current environment of the ridden vehicle, which means a hidden security of safety, so if the front lamp of the ridden vehicle is switched off at this time, then the front lamp of the ridden vehicle shall be switched on so that the driver of the ridden vehicle can watch the front road condition.
2. If the detected brightness value of light rays is not below the preset brightness threshold, then it will indicate sufficient light rays in the current environment of the ridden vehicle, and it will not be necessary to switch on the front lamp, so if the front lamp of the ridden vehicle is switched on at this time, then the front lamp of the ridden vehicle shall be switched off to thereby further conserve power so as to avoid the power from being wasted because the driver of the ridden vehicle forgets to switch off the front lamp.
3. If the detected brightness value of light rays is below the preset brightness threshold, and the front lamp of the ridden vehicle is switched on, then the current brightness of the front lamp of the ridden vehicle will be adapted to the current environment.

With the technical solution according to the embodiment of the disclosure, the brightness value of light rays in the current environment of the ridden vehicle can be detected, and the brightness value of the front lamp of the ridden vehicle can be adjusted automatically, so that the front lamp of the ridden vehicle can be switched on automatically at nighttime or if there are insufficient light rays to thereby improve the safety of the rider while riding at dark so as to better satisfy the user and to improve the experience of the user.

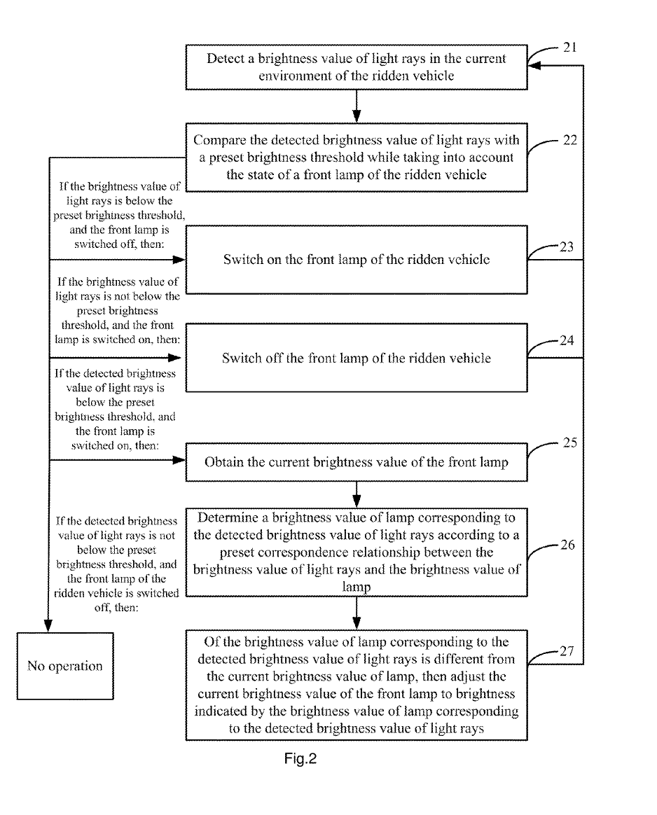

Referring to FIG. 2, an embodiment of the disclosure further provides another method for controlling a lamp in a ridden vehicle, a particular flow of which is as follows:
The step 21 is to detect brightness value of light rays in the current environment of the ridden vehicle.
The step 21 can be performed in the same or similar way to the step 11 in the first embodiment, so a repeated description thereof will be omitted here.
The step 22 is to compare the detected brightness value of light rays with a preset brightness threshold while taking into account the state of a front lamp of the ridden vehicle.

Particularly there may be the following four scenarios in total:
1. If the detected brightness value of light rays is below the preset brightness threshold, and the front lamp of the ridden vehicle is switched off, then the step 23 will be performed;
2. If the detected brightness value of light rays is not below the preset brightness threshold, and the front lamp of the ridden vehicle is switched on, then the step 24 will be performed;
3. If the detected brightness value of light rays is below the preset brightness threshold, and the front lamp of the ridden vehicle is switched on, then the step 25 will be performed; and
4. If the detected brightness value of light rays is not below the preset brightness threshold, and the front lamp of the ridden vehicle is switched off, then no operation will be performed.

The step 23 is to switch on the front lamp of the ridden vehicle.

Particularly the step 23 can be performed as follows:
A brightness value of lamp corresponding to the brightness value of light rays is determined according to a preset correspondence relationship between the brightness value of light rays and the brightness value of lamp; and
The front lamp is switched on to brightness indicated by the brightness value of lamp corresponding to the detected brightness value of light rays.

Thus the front lamp can be adjust to the appropriate brightness according to the detected brightness value of light rays to thereby avoid the brightness of the front lamp of the ridden vehicle from being adjusted to very high brightness even if the light rays are slightly insufficient, which would otherwise waste power, or avoid the brightness of the front lamp of the ridden vehicle from being adjusted to low brightness even if the light rays are very insufficient, which would otherwise hinder a driver of the ridden bicycle from see clearly a front road condition.

The step 24 is to switch of the front lamp of the ridden vehicle.

Particularly if the detected brightness value of light rays is not below the preset brightness threshold, then it will indicate sufficient light rays in the current environment of the ridden vehicle, and it will not be necessary to switch on the front lamp, so if the front lamp of the ridden vehicle is switched on at this time, then the front lamp of the ridden vehicle shall be switched off to thereby further conserve power so as to avoid the power from being wasted because the driver of the ridden vehicle forgets to switch off the front lamp.

The step 25 is to obtain the current brightness value of the front lamp.

In a real application, the brightness value of light rays in the current environment of the ridden vehicle may vary over time so that the brightness may become darker and darker or brighter or brighter, so if the detected brightness value of light rays is below the preset brightness threshold, and the front lamp of the ridden vehicle is switched on, then the current brightness of the front lamp will be adjusted to the current environment.

The step 26 is to determine a brightness value of lamp corresponding to the detected brightness value of light rays according to a preset correspondence relationship between the brightness value of light rays and the brightness value of lamp.

Particularly, instead of being performed in this order, the step 25 and the step 26 can be performed concurrently, or firstly the step 26 and then the step 25 can be performed. The embodiment of the disclosure will not be limited to any particular order in which they are performed.

The step 27 is, if the brightness value of lamp corresponding to the detected brightness value of light rays is different from the current brightness value of lamp, to adjust the current brightness value of the front lamp to brightness indicated by the brightness value of lamp corresponding to the detected brightness value of light rays.

With the technical solution according to the embodiment of the disclosure, the brightness value of light rays in the current environment of the ridden vehicle can be detected, and the brightness value of the front lamp of the ridden vehicle can be adjusted automatically, so that the front lamp of the ridden vehicle can be switched on automatically at nighttime or if there are insufficient light rays, and switched off automatically at daytime or if there are sufficient light rays, so that the front lamp of the ridden bicycle can be adapted to the varying light rays to thereby improve the safety of the rider while riding at dark so as to better satisfy the user and to improve the experience of the user.

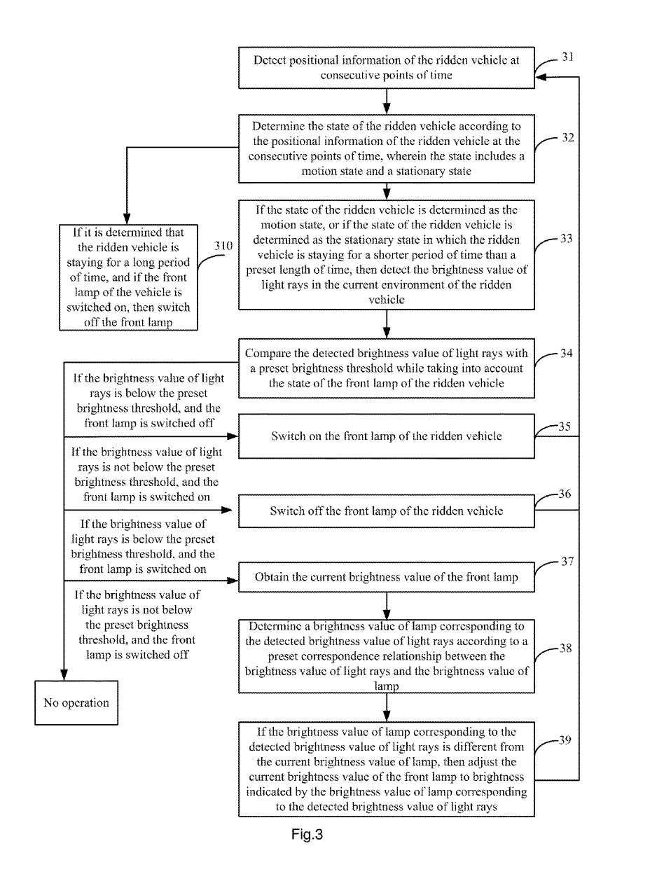

Referring to FIG. 3, an embodiment of the disclosure further provides a further method for controlling a lamp in a ridden vehicle, a particular flow of which is as follows:

The step 31 is to detect positional information of the ridden vehicle at consecutive points of time.

In an embodiment of the disclosure, the positional information of the ridden vehicle at the consecutive points of time can be detected by a Global Positioning System (GPS) sensor.

The step 32 is to determine the state of the ridden vehicle according to the positional information of the ridden vehicle at the consecutive points of time, where the state includes a motion state and a stationary state.

Particularly if the positional information of the ridden vehicle at the consecutive points of time is the same, then it will indicate that the ridden vehicle is in the stationary state, and if the positional information of the ridden vehicle at the consecutive points of time is different, then it will indicate that the ridden vehicle will be in the motion state.

Particularly if the state of the ridden vehicle is the motion state, then the front lamp will be controlled through light sensing for the sake of security.

If the state of the ridden vehicle is the stationary state including staying for a while and staying for a long period of time, then if the ridden vehicle is staying for a while, then the front lamp will still be controlled through light sensing for the sake of security, and if the ridden vehicle is staying for a long period of time, then the front lamp will not be switched on.

Thus there may be the following two scenarios dependent upon the state of the ridden vehicle as described above:
1. If the state of the ridden vehicle is determined as the motion state, or if the state of the ridden vehicle is determined as the stationary state in which the ridden vehicle is staying for a shorter length of time than a preset length of time (that is, the ridden vehicle stays for a while), then the flow will proceed to the step 33.
2. If the state of the ridden vehicle is determined as the stationary state in which the ridden vehicle is staying for the preset length of time (that is, the ridden vehicle stays for a long period of time), then the flow will proceed to the step 310.

The step 33 is, if the state of the ridden vehicle is determined as the motion state, or if the state of the ridden vehicle is determined as the stationary state in which the ridden vehicle is staying for a shorter period of time than a preset length of time, to detect the brightness value of light rays in the current environment of the ridden vehicle.

The step 34 is to compare the detected brightness value of light rays with a preset brightness threshold while taking into account the state of the front lamp of the ridden vehicle.

Particularly there may be the following four scenarios in total:
1. If the detected brightness value of light rays is below the preset brightness threshold, and the front lamp of the ridden vehicle is switched off, then the flow will proceed to the step 35;
2. If the detected brightness value of light rays is not below the preset brightness threshold, and the front lamp of the ridden vehicle is switched on, then the flow will proceed to the step 36;
3. If the detected brightness value of light rays is below the preset brightness threshold, and the front lamp of the ridden vehicle is switched on, then the flow will proceed to the step 37; and
4. If the detected brightness value of light rays is not below the preset brightness threshold, and the front lamp of the ridden vehicle is switched off, then no operation will be performed.

The step 35 is to switch on the front lamp of the ridden vehicle.

The step 36 is to switch off the front lamp of the ridden vehicle.

Particularly if the detected brightness value of light rays is not below the preset brightness threshold, then it will indicate sufficient light rays in the current environment of the ridden vehicle, and it will not be necessary to switch on the front lamp, so if the front lamp of the ridden vehicle is switched on at this time, then the front lamp of the ridden vehicle shall be switched off to thereby further conserve power so as to avoid the power from being wasted because the driver of the ridden vehicle forgets to switch off the front lamp.

The step 37 is to obtain the current brightness value of the front lamp.

In a real application, the brightness value of light rays in the current environment of the ridden vehicle may vary over time so that the brightness may become darker and darker or brighter or brighter, so if the detected brightness value of light rays is below the preset brightness threshold, and the front lamp of the ridden vehicle is switched on, then the current brightness of the front lamp will be adjusted to the current environment.

The step 38 is to determine a brightness value of lamp corresponding to the detected brightness value of light rays according to a preset correspondence relationship between the brightness value of light rays and the brightness value of lamp.

The step 39 is, if the brightness value of lamp corresponding to the detected brightness value of light rays is different from the current brightness value of lamp, to adjust the current brightness value of the front lamp to brightness indicated by the brightness value of lamp corresponding to the detected brightness value of light rays.

The step 34 to the step 39 can be performed in the same or similar way to the step 22 to the step 27 in the second embodiment, so a repeated description thereof will be omitted here.

The step 310 is if the front lamp of the ridden vehicle is switched on, to switch off the front lamp.

In the technical solution according to the embodiment of the disclosure, on one hand, if the state of the ridden vehicle is determined as the motion state, or if the state of the ridden vehicle is determined as staying for a while, then the brightness value of light rays in the current environment of the ridden vehicle can be detected, and the brightness value of the front lamp of the ridden vehicle can be adjusted automatically, so that the front lamp of the ridden vehicle can be switched on automatically at nighttime or if there are insufficient light rays, and switched off automatically at daytime or if there are sufficient light rays, so that the front lamp of the ridden bicycle can be adapted to the varying light rays; and on the other hand, if the state of the ridden vehicle is determined as staying for a long period of time, and if the front lamp of the ridden vehicle is switched on, then it will be switched off, thereby both improving the safety of the rider while riding at dark, and controlling more intelligently the front lamp to be switched on and off, so as to better satisfy the user and to improve the experience of the user.

Based upon the same inventive idea, embodiments of the disclosure further provide a system for controlling a lamp in a ridden vehicle, and a bicycle, and since the system and the bicycle address the problem under a similar principle to the method for controlling a lamp in a ridden vehicle, reference can be made to the implementation of the method for implementations of the system and the bicycle, and a repeated description thereof will be omitted here.

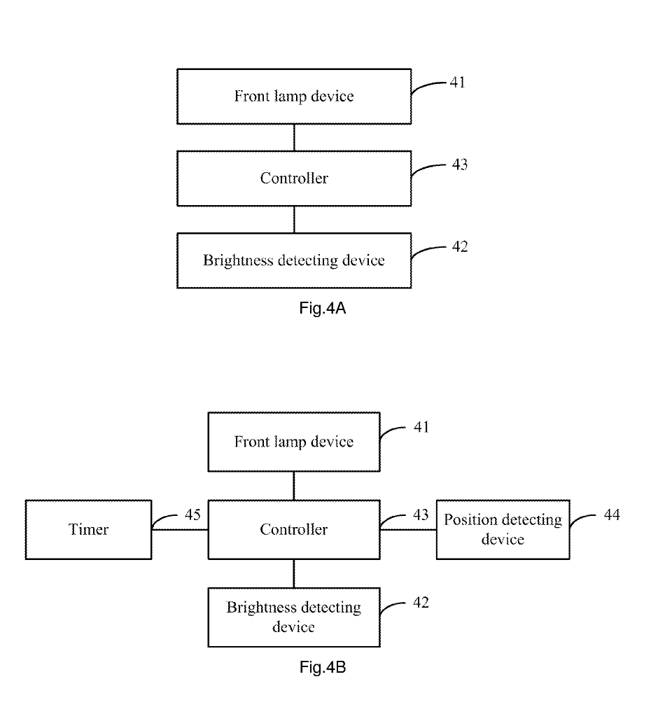

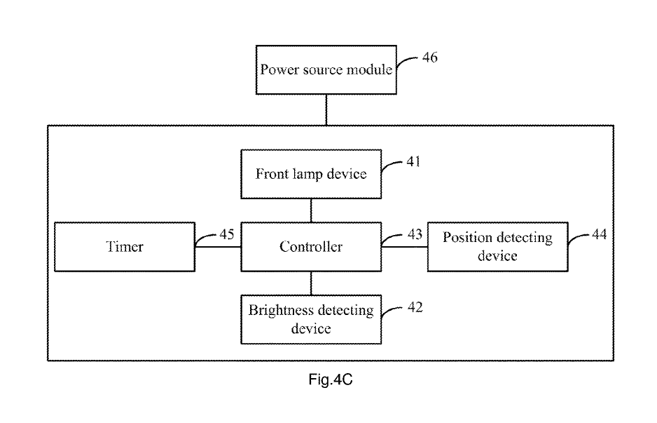

Referring to FIG. 4A, a system for controlling a lamp in a ridden vehicle according to an embodiment of the disclosure includes a front lamp device 41, a brightness detecting device 42, and a controller 43, where:
The brightness detecting device 42 is configured to detect a brightness value of light rays in the current environment of the ridden vehicle, and to transmit the brightness value of light rays to the controller 43; and
The controller 43 is configured to receive the brightness value of light rays transmitted by the brightness detecting device 42, and to control the front lamp device 41 of the ridden vehicle to be switched on and off, according to the brightness value of light rays.

Particularly the controller 43 can be configured:
If the received brightness value of light rays is below a preset brightness threshold, and the front lamp device 41 is switched off, to switch on the front lamp device 41;
If the received brightness value of light rays is not below the brightness threshold, and the front lamp device 41 is switched on, to switch off the front lamp device 41; and
If the received brightness value of light rays is below the brightness threshold, and the front lamp device 41 is switched on, to adjust the current brightness of the front lamp device 41.

Optionally the controller 43 configured, if the received brightness value of light rays is below the preset brightness threshold, and the front lamp device 41 is switched off, to switch on the front lamp device 41 can be configured:

To determine a brightness value of lamp corresponding to the brightness value of light rays according to a preset correspondence relationship between the brightness value of light rays and the brightness value of lamp; and to switch on the front lamp device 41 to brightness indicated by the brightness value of lamp corresponding to the brightness value of light rays.

Optionally the controller 43 configured, if the received brightness value of light rays is below the brightness threshold, and the front lamp device 41 is switched on, to adjust the current brightness of the front lamp device 41 can be configured:
To obtain the current brightness value of the front lamp device 41;
To determine a brightness value of lamp corresponding to the brightness value of light rays according to a preset correspondence relationship between the brightness value of light rays and the brightness value of lamp; and
If the brightness value of lamp corresponding to the brightness value of light rays is different from the current brightness value of lamp, to adjust the current brightness value of the front lamp device 41 to brightness indicated by the brightness value of lamp corresponding to the brightness value of light rays.

Optionally the front lamp device 41 in an embodiment of the disclosure is typically a lamp including a reflecting mirror and a specialized lens, which can be installed at the front of the vehicle body. Particularly the front lamp device 41 can be an illumination lamp configured to illuminate a front road so that a driver of the ridden vehicle can observe the road condition in front of the vehicle, or the front lamp device 41 can be a width indicating lamp, or a contour indicating lamp, which is an indicating lamp installed to indicate the width of the traveling vehicle to another vehicle at nighttime.

Either the illumination lamp or the width indicating lamp can include but will not be limited to a Light Emitting Diode (LED) lamp.

Optionally the brightness detecting device 42 in an embodiment of the disclosure can include but will not be limited to a brightness sensor which can be installed on the body of the ridden vehicle. It can be installed at the front of the body of the vehicle for the sake of a more pronounced effect.

Optionally the controller 43 can include but will not be limited to one of a monolithic processor, a Field Programmable Gate Array (FPGA), and a Digital Signal Processor (DSP).

In summary, in the embodiment of the disclosure, the brightness value of light rays in the current environment of the ridden vehicle can be detected, and the brightness value of the front lamp of the ridden vehicle can be adjusted automatically, so that the front lamp of the ridden vehicle can be switched on automatically at nighttime or if there are insufficient light rays, and switched off automatically at daytime or if there are sufficient light rays, so that the front lamp of the ridden bicycle can be adapted to the varying light rays to thereby improve the safety of the rider while riding at dark so as to better satisfy the user and to improve the experience of the user.

Referring to FIG. 4B illustrating another system for controlling a lamp in a ridden vehicle according to an embodiment of the disclosure, the system includes:

A front lamp device 41, a brightness detecting device 42, a controller 43, a position detecting device 44, and a timer 45, where:

The front lamp device 41, the brightness detecting device 42, and the controller 43 are as described in FIG. 4A.

The position detecting device 44 is configured to obtain and transmit positional information of the ridden vehicle at consecutive points of time to the controller 43.

The controller 43 is configured:
To receive the positional information of the ridden vehicle at the consecutive points of time transmitted by the position detecting device 44; to determine the state of the ridden vehicle according to the positional information of the ridden vehicle at the consecutive points of time, where the state includes a motion state and a stationary state; if the state of the ridden vehicle is determined as the stationary state, to transmit a timing start instruction to the timer 45; and if the state of the ridden vehicle is determined as the motion state, or if the state of the ridden vehicle is determined as the stationary state and a timing end message fed back by the timer 45 is not received, to control the front lamp device 41 of the ridden vehicle to be switched on and off, according to the brightness value of light rays.

Optionally the timer 45 is configured to receive the timing start instruction transmitted by the controller 43, and if a preset length of time for timing elapses, to feed the timing end message back to the controller 43; and

The controller 43 is further configured:
If the state of the ridden vehicle is determined as the stationary state, the timing end message fed back by the timer 45 is received, and the front lamp device 41 is switched on, to switch off the front lamp device 41.

Optionally the position detecting device 44 in an embodiment of the disclosure can be a Global Positioning System (GPS) sensor which can be installed on the body of the ridden vehicle.

Optionally the ridden vehicle in an embodiment of the disclosure can include one of a bicycle, an electric vehicle, and a motorcycle.

In summary, in the embodiment of the disclosure, on one hand, if the state of the ridden vehicle is determined as the motion state, or if the state of the ridden vehicle is determined as staying for a while, then the brightness value of light rays in the current environment of the ridden vehicle can be detected, and the brightness value of the front lamp of the ridden vehicle can be adjusted automatically, so that the front lamp of the ridden vehicle can be switched on automatically at nighttime or if there are insufficient light rays, and switched off automatically at daytime or if there are sufficient light rays, so that the front lamp of the ridden bicycle can be adapted to the varying light rays; and on the other hand, if the state of the ridden vehicle is determined as staying for a long period of time, then if the front lamp of the ridden vehicle is switched on, then it will be switched off, thereby both improving the safety of the rider while riding at dark, and controlling more intelligently the front lamp to be switched on and off, so as to better satisfy the user and to improve the experience of the user.

Referring to FIG. 4C illustrating a further system for controlling a lamp in a ridden vehicle according to an embodiment of the disclosure, the system includes:

A front lamp device 41, a brightness detecting device 42, a controller 43, a position detecting device 44, a timer 45, and a power source module 46, where:

The front lamp device 41, the brightness detecting device 42, the controller 43, the position detecting device 44, and the timer 45 are as described in FIG. 4B.

The power source module 46, connected with the front lamp device 41, the brightness detecting device 42, the controller 43, the position detecting device 44, and the timer 45, is configured to power the front lamp device 41, the brightness detecting device 42, the controller 43, the position detecting device 44, and the timer 45.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for controlling a lamp in a ridden vehicle, the method comprising:
detecting a brightness value of light rays in the current environment of the ridden vehicle; and
controlling the front lamp of the ridden vehicle to be switched on and off, according to the brightness value of light rays.

2. The method according to claim 1, wherein controlling the front lamp of the ridden vehicle to be switched on and off, according to the brightness value of light rays comprises:
if the brightness value of light rays is below a preset brightness threshold, and the front lamp of the ridden vehicle is switched off, then switching on the front lamp;
if the brightness value of light rays is not below the brightness threshold, and the front lamp of the ridden vehicle is switched on, then switching off the front lamp; and
if the brightness value of light rays is below the brightness threshold, and the front lamp is switched on, then adjusting the current brightness of the front lamp.

3. The method according to claim 2, wherein switching on the front lamp comprises:
determining a brightness value of lamp corresponding to the brightness value of light rays according to a preset correspondence relationship between the brightness value of light rays and the brightness value of lamp; and
switching on the front lamp to brightness indicated by the brightness value of lamp corresponding to the brightness value of light rays.

4. The method according to claim 2, wherein adjusting the current brightness of the front lamp comprises:
obtaining the current brightness value of the front lamp;
determining a brightness value of lamp corresponding to the brightness value of light rays according to a preset correspondence relationship between the brightness value of light rays and the brightness value of lamp; and
if the brightness value of lamp corresponding to the brightness value of light rays is different from the current brightness value of lamp, then adjusting the current brightness value of the front lamp to brightness indicated by the brightness value of lamp corresponding to the brightness value of light rays.

5. The method according to claim 1, wherein the method further comprises:
detecting positional information of the ridden vehicle at consecutive points of time;
determining the state of the ridden vehicle according to the positional information of the ridden vehicle at the consecutive points of time, wherein the state comprises a motion state and a stationary state; and
detecting the brightness value of light rays in the current environment of the ridden vehicle comprises:
if the state of the ridden vehicle is determined as the motion state, or if the state of the ridden vehicle is determined as the stationary state in which the ridden vehicle is staying for a shorter length of time than a preset length of time, then detecting the brightness value of light rays in the current environment of the ridden vehicle.

6. The method according to claim 5, wherein the method further comprises:
if the state of the ridden vehicle is determined as the stationary state in which the ridden vehicle is staying for the preset length of time, and the front lamp of the ridden vehicle is switched on, then switching off the front lamp of the ridden vehicle.

7. A system for controlling a lamp in a ridden vehicle, the system comprising a front lamp device, a brightness detecting device, and a controller, wherein:
the brightness detecting device is configured to detect a brightness value of light rays in the current environment of the ridden vehicle, and to transmit the brightness value of light rays to the controller; and
the controller is configured to receive the brightness value of light rays transmitted by the brightness detecting device, and to control the front lamp device of the ridden vehicle to be switched on and off, according to the brightness value of light rays.

8. The system according to claim 7, wherein the controller is configured:
if the brightness value of light rays is below a preset brightness threshold, and the front lamp device is switched off, to switch on the front lamp device;
if the brightness value of light rays is not below the brightness threshold, and the front lamp device is switched on, to switch off the front lamp device; and
if the brightness value of light rays is below the brightness threshold, and the front lamp device is switched on, to adjust the current brightness of the front lamp device.

9. The system according to claim 8, wherein the controller is configured:
to determine a brightness value of lamp corresponding to the brightness value of light rays according to a preset correspondence relationship between the brightness value of light rays and the brightness value of lamp; and to switch on the front lamp device to brightness indicated by the brightness value of lamp corresponding to the brightness value of light rays.

10. The system according to claim 8, wherein the controller is configured:
to obtain the current brightness value of the front lamp device;
to determine a brightness value of lamp corresponding to the brightness value of light rays according to a preset correspondence relationship between the brightness value of light rays and the brightness value of lamp; and
if the brightness value of lamp corresponding to the brightness value of light rays is different from the current brightness value of lamp, to adjust the current brightness value of the front lamp device to brightness indicated by the brightness value of lamp corresponding to the brightness value of light rays.

11. The system according to claim 7, wherein the system further comprises a position detecting device and a timer, wherein:
the position detecting device is configured to obtain and transmit positional information of the ridden vehicle at consecutive points of time to the controller; and
the controller is configured:
to receive the positional information of the ridden vehicle at the consecutive points of time transmitted by the position detecting device; to determine the state of the ridden vehicle according to the positional information of the ridden vehicle at the consecutive points of time, wherein the state comprises a motion state and a stationary state; if the state of the ridden vehicle is determined as the stationary state, to transmit a timing start instruction to the timer; and if the state of the ridden vehicle is determined as the motion state, or if the state of the ridden vehicle is determined as the stationary state and a timing end message fed back by the timer is not received, to control the front lamp device of the ridden vehicle to be switched on and off, according to the brightness value of light rays.

12. The system according to claim 11, wherein the timer is configured to receive the timing start instruction transmitted by the controller, and if a preset length of time for timing elapses, to feed the timing end message back to the controller; and
the controller is further configured:
if the state of the ridden vehicle is determined as the stationary state, the timing end message fed back by the timer is received, and the front lamp device is switched on, to switch off the front lamp device.

13. The system according to claim 7, wherein the ridden vehicle comprises one of a bicycle, an electric vehicle, and a motorcycle.
